(19) United States
(12) Patent Application Publication
(10) Pub. No.: US 2003/0103439 A1
(43) Pub. Date: Jun. 5, 2003

(54) Optical pickup apparatus for small optical disk

(76) Inventors: Shogo Horinouchi, Fukuoka (JP); Hideki Yoshinaka, Chikushino-shi (JP); Shin Ishibashi, Fukuoka (JP); Fuminobu Furukawa, Onojo-shi (JP)

Correspondence Address: STEVENS, DAVIS, MILLER & MOSHER, L.L.P., Suite 850, 1615 L Street, N.W., Washington, DC, 20036, US

(21) Appl. No.: 10/301,647

(22) Filed: Nov. 22, 2002

(30) Foreign Application Priority Data
Nov. 30, 2001 (JP) 2001-366008

(51) Int. Cl. G11B 7/135

(52) U.S. Cl. 369/112.23

(57) ABSTRACT

Provided are an optical pickup apparatus which is used for recording and reproducing a small-sized optical disc and which is small-sized, lightweight and inexpensive, and an optical disc unit, including an optical head which comprises a lens holder engaged and fixed to an arm, an objective lens fixed to that side which is opposed to the optical disc, a semiconductor laser arranged on a surface side which is in rear of the former surface, and a reflection mirror for guiding a light beam to the objective lens, the semiconductor laser being arranged on an OEIC through the intermediary of a submount, on that surface side which is on the rear surface side of the lens holder.

### BACKGROUND OF THE INVENTION

The present invention relates to an optical pick-up apparatus used for recording and reproducing data onto and from an optical disk, a method of assembling the optical pickup apparatus, a method of detecting an optical signal with the use of the pickup apparatus, and an optical disk unit using the optical pickup apparatus.

(Field of the Invention)

Optical disk units have a mass-storage volume, and facilitate their handling, and accordingly, it is widely used for a storage apparatus for a computer equipment. Further, the downsizing of computer equipment and the development thereof into mobile type have inevitably and greatly caused the downsizing of optical disk units to be used therein. For example, a mini-disk (MD) apparatus is the typical one thereof, using a pickup which was proposed in JP-A-7-311989, JP-A-8-161768 etc., and which has practically been used.

Meanwhile, hard-disk units have become of mass storage-volume type and small-sized, and are widely used in mobile type computer equipment. These hard disk units utilize a magnetic head as disclosed in JP-A-2001-250343.

In the present invention, an optical disk should not be limited to a specific one but is representative of recording media onto and from which data can be recorded and reproduced with the use of optical beams, regardless of any one of such recording types that condensation and rarefaction in recording density are used, wave lengths of optical beams are used or magnetism is additionally used, regardless of any one of shapes such as a disk-like shape or a name-card shape, and regardless of any one of such mounting types such as a fixed type, a replaceable type or a jacket accommodation type.

However, widespread mobile type computer equipment, development of mobile type communication equipment and proposition of new IT business cause the marketplace to demand further miniaturization of disk units.

### SUMMARY OF THE INVENTION

Thus, in order to satisfy the above-mentioned demands in the market place, the present invention proposes an optical pickup apparatus from a new point of view, and accordingly, an object of the present invention is to provide an optical pickup apparatus which is used for recording and reproducing data to and from a small-sized optical disk and which is small-sized, lightweight and inexpensive, and also to provide an optical disk unit using this optical pickup apparatus.

To the end, according to the present invention, there is provided an optical pickup apparatus comprising a swing means arranged so as to be swingable over a recording surface of a recording medium; a swingable drive means for swingably driving the swinging means, a bringing means for bringing the swing means to and from the recording medium, and an optical head arranged at a swing end part of the swing means, for recording and reproducing data onto and from the recording medium, characterized in that the optical head comprises a holder member engaged and fixed to the swing means, an objective lens fixed to a surface of the holder member on that side which is opposed to the recording medium, a light source arranged on a rear surface side of the surface opposed to the recording medium and a reflection mirror for guiding an optical beam from the light source to the objective lens through a through hole piercing through the front end part of the holder member, and the light source is arranged on a light receiving means through the intermediary of a heat radiation member arranged on the rear surface side of the surface which is opposed to the recording medium.

With the above-mentioned configuration, there may be provided an optical pickup apparatus which is small-sized, lightweight and expensive so as to be usable for recording and reproducing data onto and from a small-sized optical disk, and an optical disk unit using this optical pickup unit.

### BRIEF DESCRIPTION OF THE DRAWINGS

FIG. 1 is a perspective view illustrating an essential part of an optical disk unit;

FIG. 2 is a perspective view illustrating an optical pickup (swing arm) shown in FIG. 1;

FIG. 3a is a side view illustrating an optical head as viewed in the direction of the arrow A shown in FIG. 2;

FIG. 3b is an exploded perspective view illustrating the optical head shown in FIG. 2;

FIG. 4 is an enlarged wiring diagram illustrating an OEIC;

FIG. 5 is an enlarged perspective view illustrating the rear surface of the optical head;

FIG. 6 is a sectional view for explaining the internal structure of a polarizing plate; and

FIG. 7 is a perspective view for explaining the assembly of the optical head; and

FIG. 8 is a view for explaining an optical configuration of the optical head according to the present invention.

### DESCRIPTION OF THE PREFERRED EMBODIMENTS

Explanation will be hereinbelow made embodiments of the present invention with reference to the accompanying drawings.

(Embodiment 1)

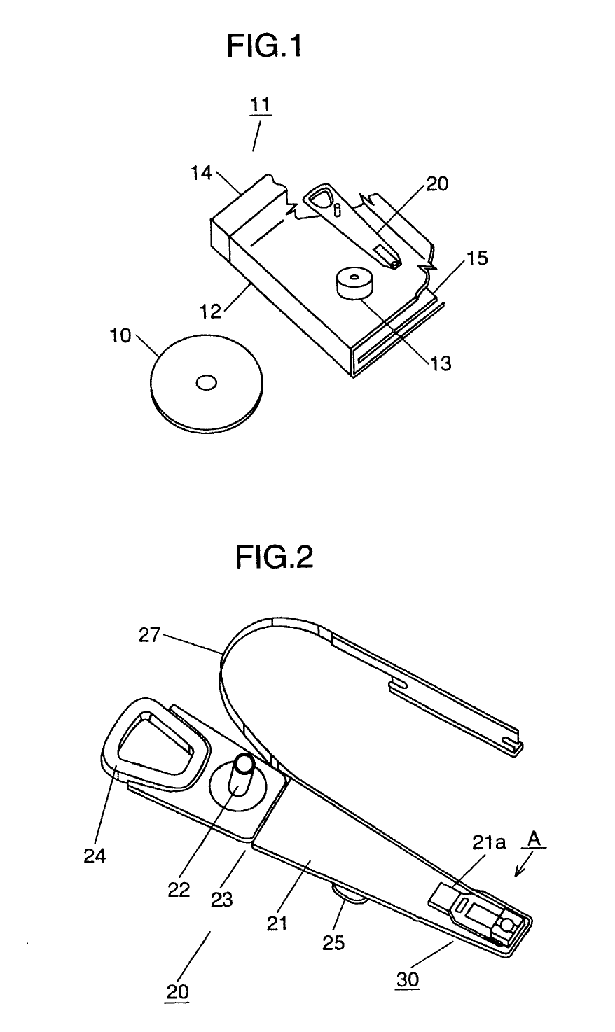

Referring to FIG. 1 which is a perspective view illustrating an essential part of an optical disk unit in an embodiment 1 of the present invention, and in which a housing is partly broken so as to show main components thereof in order to manifest the main purpose of the present invention. Referring to FIG. 1, there are shown an optical disk 10 used in the optical disk unit according to the present invention and having a diameter smaller than that of an MD so as to be conveniently used for a mobile unit, a housing 12 for protecting the entire configuration of the optical disk unit and for holding therein the components thereof. Further, the housing has an opening (which is not shown) through which the optical disk 10 can be mounted and removed.

Further, there are shown a spindle motor 13 for rotating the optical disk 10 mounted thereon at a predetermined rotational speed, an IF unit 14 for receiving and transmitting signals to be recorded or reproduced to and from the optical disc 10, from and to an external equipment, which is may be any one of a connector and a MODEM which are of wire-communication type, and a wireless-communication unit, and a circuit board 15 for controlling the apparatus in its entirety and for driving the components.

There is also shown an optical pickup (swing arm) 20 which is adapted to swing over a recording surface of the optical disk 1 between the inner perimeter and the outer perimeter thereof, and which will be denoted not only as an optical pickup in view its function, and but also a swing arm in view of its mechanical operation. Referring to FIG. 2 which is a perspective view illustrating an essential part of the optical pickup (swing arm) 20 shown in FIG. 1, there are shown an arm 21, as a swing means, which is formed so as to be rigid throughout the arm 21 in order to ensure an accurate position for the optical system, a shaft 22 serving as a fulcrum for the swing motion of the arm 21, the swing arm 20 being journalled to the housing 12 through the intermediary of the shaft 22, a hinge 23 which is a sole flexing portion of the arm 21 so that the bringing motion (focusing operation) of the arm 21 to and from the optical disk 10 can be precisely controlled.

Further, there are shown a tracking coil 24 and a focus coil 25 serving as a bringing means. When the tracking coil 24 is energized, an attraction force and a repulsion force are produced between the tracking coil 24 and a magnet (which is not shown) located in the housing 12, and accordingly, the arm 21 can swing between the inner perimeter to the outer perimeter of the optical disk 10 about the shaft 22 as a fulcrum. Further, the focus coil also produces an attraction force and a repulsion force between itself and a magnet (which is not shown) located in the housing 12 so as to allow the arm 23 to carry out focusing operation about the hinge 23 as a flex point. Further there is shown a flexible cable 27 (which will be hereinbelow abbreviated as FPC). Signals from the tracking coil 24, the focusing coil 25 and an optical head which will be explained later, are transmitted to the circuit board 15.

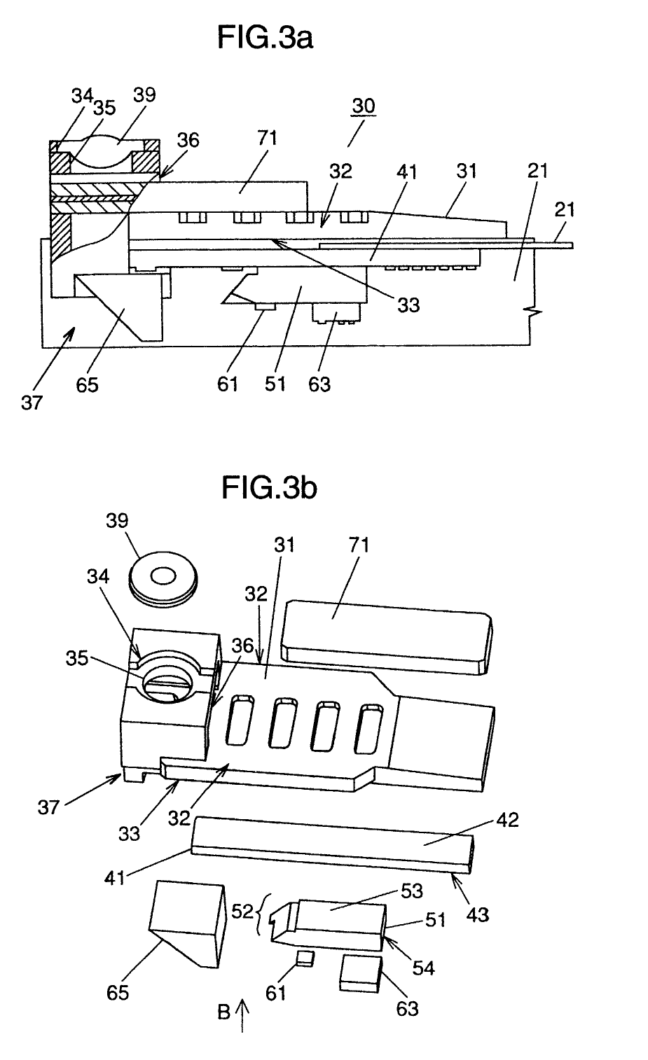

The distal end part of the arm 21 is formed therein with a rectangular aperture 21a in which the optical head 30 is fixed. FIG. 3a is a view illustrating an entire configuration of the optical head 30 shown in FIG. 2. In detail, FIG. 3a is a side view as viewed in the direction of the arrow A shown in FIG. 2, illustrating a structure of that part of the arm 21 which is indicated by the arrow A, being partly broken. In this figure, the radial direction of the optical disk 10 is normal to the surface of the drawing, and the direction tangential to the optical disk 10 in the lateral direction of the sheet thereof. FIG. 13b is an exploded perspective view illustrating the optical head, in which the arm 21 is not shown in order to facilitate the understanding of the configuration of the optical head.

The arm 21 is fixed thereto with a lens holder 31 as a holding member, which is an essential structure for holding all optical components including an objective lens 39. The lens holder 31 is formed on opposite sides thereof with planar flange parts 32, respectively, which horizontally bulge out. The lower surfaces 33 of the flange parts 31 are fixed to the aperture 21a in the arm 21 by means of adhesive. It is noted that the front surface side is exhibited to be that side which is opposed to the optical disk 10 and the rear surface side is exhibited to be that side which is in opposite to the former for convenience of the explanation which will be hereinbelow made.

The distal end part of the lens holder 31 is projected toward the optical disk 10 so as to be formed in a portal shape, and a circular stepped part and a circular through-hole 35 are formed in the portal shape front end part, the stepped part serving as a holder part 34 for fixing the objective lens 39 and the circular through-hole 35 serves as a light guide path for light passing through the objective lens 39.

The diameter of the circular through-hole 35 is set so that the objective lens 39 has a desired NA. Accordingly, the circular through-hole 35 may also serve as a lens aperture member. Further, since it is integrally incorporated with the holder part 34 for fixing the objective lens 39, no positional adjustment between the objective lens 39 and the lens aperture member is required, and accordingly, the assembly thereof can be made at low manufacturing costs with a high degree of accuracy. A space is defined between projected opposite legs of the portal shape front end part of the lens holder 31, orthogonal to the circular through-hole 35. This space serves as a polarizing plate mounting part 36 for mounting a polarizing plate 71 which will be explained later.

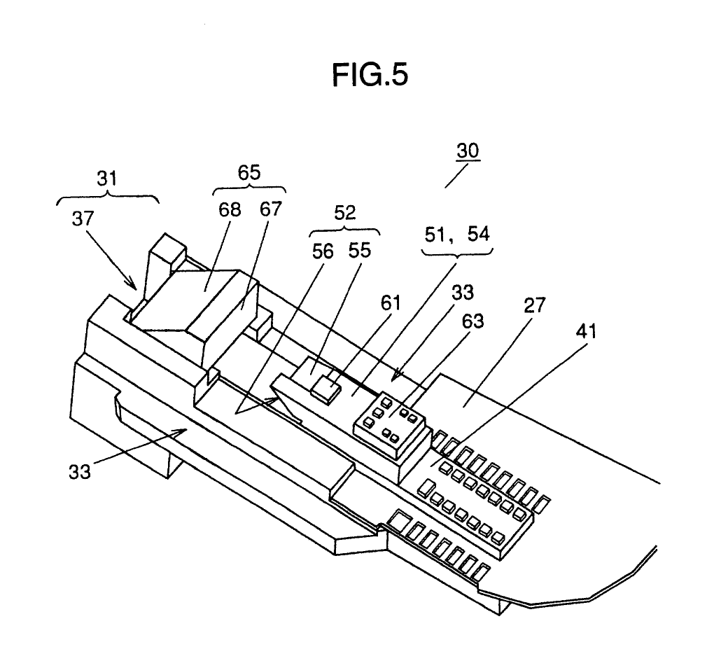

The lens holder 31 is formed on the rear surface side thereof with a stepped part in the front end part thereof and a planar part in the center part thereof. The stepped part in the front end part serves as a mirror fixing part 37 (which is best shown in FIG. 5) for fixing a reflection mirror 65. The OEIC 41 serving as a light receiving means is mounted on the planar part. The OEIC 41 is formed in a planar shape, having a front surface 42 fixed to the lens holder 31 and a rear surface serving as a wiring surface 43.

The OEIC 41 is mounted thereon with a submount 51 serving as a heat radiation member. The submount 51 is formed in a planar shape, having a ramp 52 in the front end part thereof and having a front planer surface serving as a surface 53 fixed to the OEIC 41 and a rear planar surface serving as a mounting surface 54 mounted thereon with a semiconductor laser 61 as a light source and an HFM (high frequency module) 63. The HFM 63 is the module for subjecting the semiconductor laser 61 to high frequency modulation and energizing the same. Since high frequency current is processed, a mounting method in which it is isolated or shielded from a signal system is in general used, but since it is mounted on the submount 51, it can incorporate both isolation function and shield function.

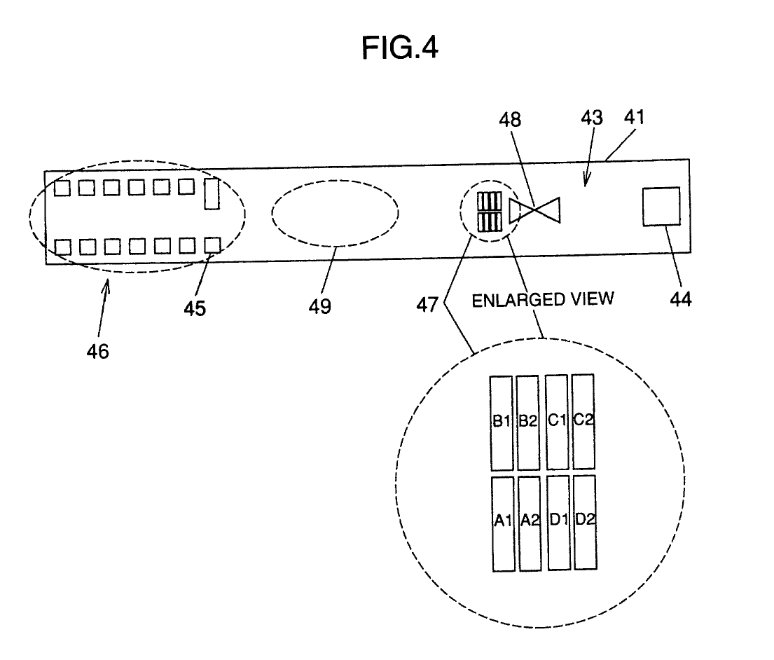

Referring to FIG. 4 which is an enlarged view illustrating the wiring surface 43 of the OEIC 41, as viewed in the direction of the arrow B in FIG. 3b. Referring to FIG. 4, there are shown a monitor beam receiving portion 44 for detecting an output power (light power) of a light beam emitted by the semiconductor laser 61, and is adapted to be used for controlling the output power of the semiconductor laser 61, terminals 45 for wiring the power source and signal lines, the terminals 45 being bundled in a terminal portion 46 so as to enhance the working efficiency of wire bonding, and a detected light receiving portion 47 in which a plurality of light receiving elements are arranged as shown in the partly enlarged view so as to produce a reproducing signal and control signals for focusing and tracking in accordance with a reflecting light beam from the optical disk 10.

It is noted that the OEIC 41 may be formed by cutting a silicon substrate (silicon wafer) in a rectangular shape. Thus, required light receiving elements (the monitor beam receiving portion 44 and the detected light receiving portion 47), current-voltage transducer elements (for example, resistors) for the former, signal amplifiers and required internal wiring may have been formed in the silicon substrate (OEIC 41).

Further, although explanation has been made of the HFM (high frequency module) 63 which is mounted, for example, on the submount 51, HFM 63 may be also mounted on the OEIC 41. Further, it may be formed as an integrated circuit in the silicon substrate for the OEIC 41. It is noted that reference numeral 48 denotes a reference marker adapted to be used for precisely locating the mounting positions of the submount 51 and the semiconductor laser 61. A planer space in the center part serves as a mount mounting portion 49 to which the fixing surface 53 of the submount 51 is fixed with the use of adhesive.

Referring to FIG. 5 which is an enlarged perspective view illustrating the rear surface of the optical head 30, as viewed in the direction of the arrow B shown in FIG. 3b, the ramp 52 of the submount 51 is composed of two slope surfaces one of which is an emission slope surface 55 for blocking emission light from the semiconductor laser 61, and is formed being moderately inclined toward the front surface of the lens holder 31, and the other one of which is a light receiving slope surface 56 which is inclined reversely as viewed from the mounting surface 54, and which reflects a reflection light beam from the optical disc 10 in order to guide the same onto the detected light receiving portion 47. The light receiving slope surface 56 is coated thereover with a reflection film in order to efficiently reflect the reflection light beam from the optical disk 10. Alternatively, the inclined angle of the light receiving slope surface 56 is set to a value with which a reflection light beam from the optical disk 10 is totally reflected thereby, and accordingly, the reflection light beam can be efficiently reflected. It is required to effect an optical reflecting characteristic in which the reflectance ratio with respect to P-polarized light may be enhanced. It is because, as will be explained later, the reflection light beam from the optical disk 10 is reflected at the light receiving slope surface 56 with P-polarization.

The submount 51 is mounted thereon with the semiconductor laser 61, and accordingly, is made of a material which has a thermal expansion coefficient equal to that of the semiconductor laser 61 and which has a thermal conductivity higher than that of the same. For example, silicon materials (SiN), aluminum nitride (Al₃N₂) or the like may preferably be used. Further, the submount 51 may be formed by machining, etching or the like. Thus, it is possible to prevent the joined surfaces from being broken, being caused by heat generation, and further, heat by emission light from the semiconductor laser 61 can be efficiently radiated. Further, the lens holder 31 may be formed therein with a receiving surface (which is not shown) to which the submount 51 is joined. With this arrangement, there may be materialized such a structure that heat generated from the semiconductor laser 61 can be radiated toward the lens holder 31 by way of the submount 51.

A reflection mirror 65 is a prism having a triangular prism-like shape having an incident surface 67 onto which an emission light beam from the semiconductor laser 61 is incident, and a reflecting surface 68 for reflecting the light beam toward the objective lens 39. Since the OEIC 41 and the submount 51 are both formed in the parallel planar plate shapes, the reflecting surface 68 are formed at an angle of 45 deg. with a high degree of accuracy. The reflecting surface 68 is coated thereover with a reflective film, while the incident surface 67 is coated thereover with an anti-reflective film in order to efficiently reflect a reflection light beam from the optical disk 10 and to prevent stray light from entering. Both incident surface 67 and reflecting surface 68 should have optical reflection characteristics so as to have high reflectance ratio with respect to both S-polarization and P-polarization. The reason is such that the emission light beam from the semiconductor laser 61 has S-polarization and the reflection light beam from the optical disk 10 has P-polarization. Further, in order to materialize the optical reflection characteristics with a dielectric multi-layer film, the reflection mirror 65 desirably such a triangular prism-like shape that the reflecting surface 68 becomes an interface between glass and air.

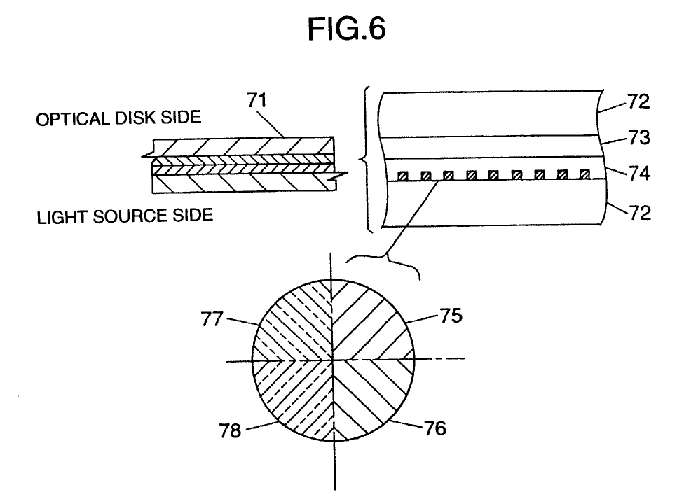

Referring to FIG. 6 which is a sectional view for explaining an internal structure of the polarizing plate 71, along the traveling direction of the optical beam, the side above the sheet surface is the optical disc 10 side, and the side under the sheet surface is the optical source side. Accordingly, an out-going light beam travels from the side under the sheet surface to the side below the sheet, while the reflection beam from the optical disk 10 travels from the side above the sheet surface to the side under the sheet surface. The polarizing plate 71 is a composite polarization hologram which is formed from a stack of multi-layers in the form of a parallel planar plate. At first, both front and rear surface are light guide members 72 which are made of optically transparent resin or optical glass. Among others, Optical glass SFL-1.6 or BK-7 has a high refractive index so as to obtain a large design margin for a refraction grating or a film, and exhibits such a characteristic that a wave shift can hardly be caused upon transmission of light therethrough. Among all, BK-7-1.5 is highly preferable since it is excellent in workability and commercially available.

An internal first layer is a quarter wave plate 73 which is laid so that the direction of the optical axis is set to an angle of 90 deg. with respect to the direction of polarization of the out-going light beam when the phase of the light is changed.

An internal second layer is a hologram film 74 which is formed by forming a highly light transparent resin material into a thin film and selectively changing the optical guide characteristic by means of irradiation of an ion beam or the like. This light guide characteristic is such that the refractive index of the part which is processed by irradiation of an ion beam is equal to that of a part which is not processed by irradiation of an ion beam or the like in view of the polarizing direction of the out-going light beam or the like, while the refractive index of the part which is processed by irradiation of an ion beam or the like is different from that of the part which is not processed by irradiation of an ion beam or the like in view of the polarizing direction of the reflection light from the optical disk 10. Further, if the irradiation of an ion beam or the like is carried out in a grid-like manner, a function as a polarization property refraction grating can be obtained. Further, a lattice-like configuration is set up so that a reflection light beam from the optical disc 10 is led to a predetermined light receiving element in the detected light receiving portion 47. Thus, as the polarization hologram, there may have such a function that the out-going light beam and the incoming light beam can be separated from each other on the optical path.

The refraction grating formed as mentioned above, is shown in FIG. 6 which is a partly enlarged view. In the case of the present invention, it is formed through quarter division into refraction gratings 75 to 78. The center of the diffraction gratings 75 to 78 which are subjected to quarter division is precisely aligned with the optical axis when the polarizing plate 71 is mounted in the lens holder 31.

The polarizing plate 71 is formed in the composite polarization hologram, and accordingly, the manufacture thereof can be facilitated. In comparison with such a case that the optical guide members 72 are etched so as to form diffraction gratins, the fabrication thereof is simple, and further, more precise diffraction gratings can be formed. Further, since they are thin films having no unevenness in diffraction gratings, and accordingly, they are surely joined to one another.

Further, in the configuration of this embodiment, it is formed in two layers, that is, the quarter wave plate 73 and the hologram film 74. Thus, if the quarter wave plate 73 is made of the same material as that of the hologram film 74, a hologram quarter wave plate 73 can be formed by irradiation of an ion beam onto the quarter wave plate 73. Thereby, it is possible to reduce the number of necessary components.

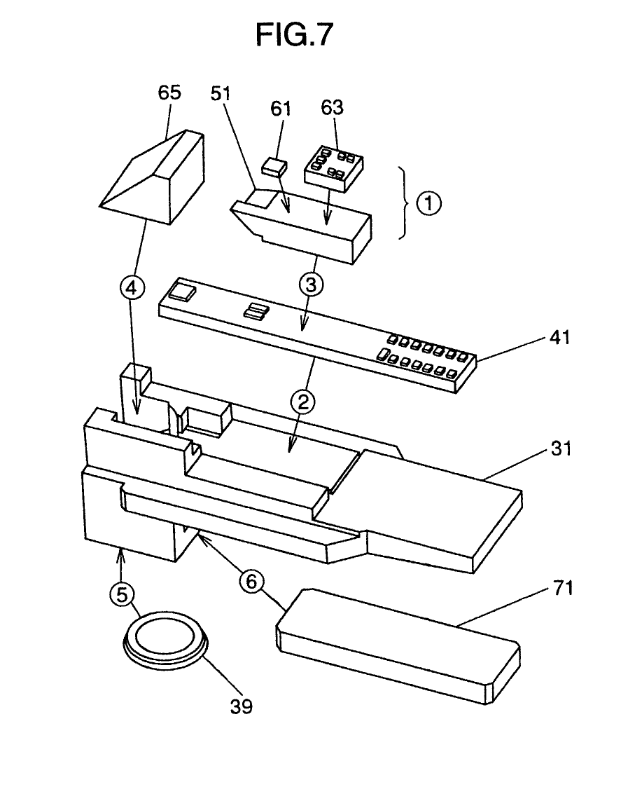

Explanation will be hereinbelow made of the assembly of the components mentioned above. Referring to FIG. 7 for explaining the assembly of the optical head 30, the FPC 27 has been previously bonded to the lens holder 31. Further, the submount 51 has been previously bonded thereto with the semiconductor laser 61 and the HFM (high frequency module) 63. In the case of managing the submount 51 as a single stock, the semiconductor laser 61 and the submount 51, and the HFM 63 and the Submuont 51 are connected therebetween with bonding wires, and an operating test has been able to be made thereto as a single stock ((1) in FIG. 7).

Then, the OEIC 41 is bonded to the lens holder 31 ((2) in FIG. 7), and the submount 51 which has been a singly stock is bonded to the mount mounting part 49 of the OEIC 41 ((3) in FIG. 7). At this time, the terminal part 46 of the EIC 41 and the HFM 63 are connected therebetween with bonding wires. It is noted that the above-mentioned wire-bonding to the submount 51 may be made simultaneously at this time.

Further, the reflection mirror 65 is bonded to the mirror fixing part 37 of the lens holder 31 ((4) in FIG. 7), and the objective lens 39 is bonded to the holder part 34 of the lens holder 31 ((5) in FIG. 7). Finally, a dummy reflection mirror is located, in stead of the optical disk 10, the semiconductor laser 61 is empirically energized so as to emit a light beam in order to monitor a receiving condition of a reflection light beam while the polarizing plate 71 is bonded and fixed to the polarizing plate mounting part 36 of the lens holder 31 after positional adjustment is made for the polarizing plate 71 ((6) in FIG. 7).

As mentioned above, all optical components are fixed to the lens holder 31 or are stacked one upon another and thereafter are fixed. Thus, the assembly thereof can be made by a simple assembling procedure, and accordingly, the manufacture thereof can be facilitated, thereby it is possible to aim at reducing manhours. Adjustment in assembly is required at only one step at which the position of the polarizing plate is adjusted, and accordingly, there may be offered such an arrangement that the adjustment can be facilitated. Further, as mentioned above, the number of necessary components is not more than 9, the number of necessary components and the costs of the components can be greatly reduced. In addition, the above-mentioned manhours can be reduced, thereby it is possible to provide an inexpensive optical head 30.

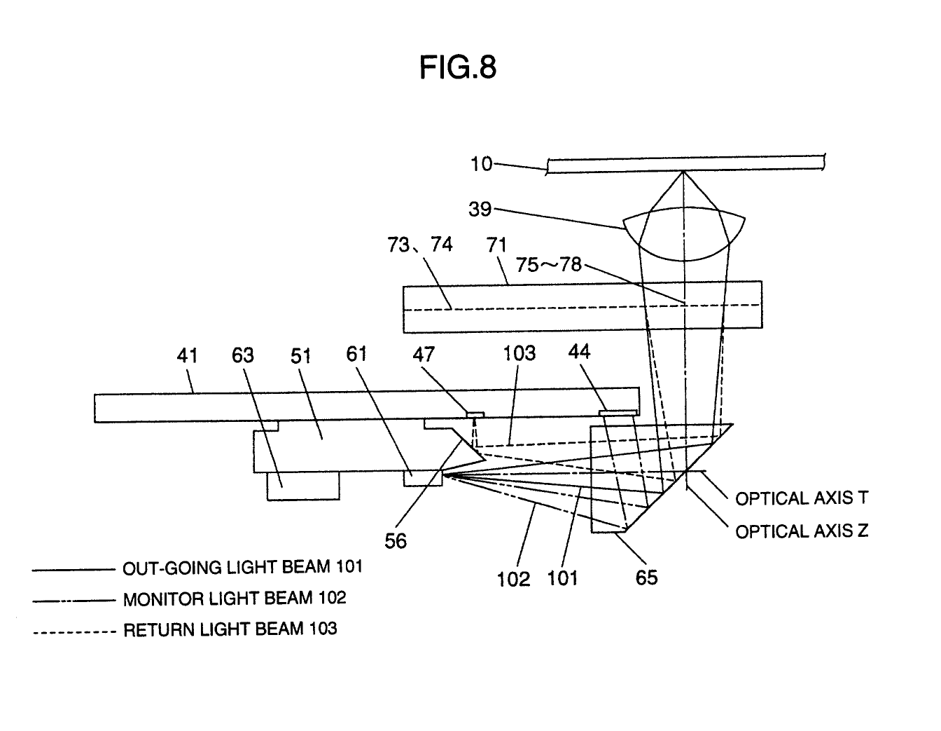

Explanation will be hereinbelow made of the optical configuration of the optical head 30 according to the present invention, which have been assembled as stated above. Referring to FIG. 8 which is a view for explaining the optical configuration of the optical head 30 according to the present invention, and which exhibits such a condition that the optical components of the optical head 30 shown in FIG. 2 are sectioned along the optical axis (optical axis T which will be explained later) of the emitted light beam from the semiconductor laser 61, a light beam (which will be hereinbelow simpy denoted as “out-going light beam 101”) which is emitted from the semiconductor laser 61 to the optical disk. This light beam is indicated by the solid line in order to show an optical transmission path. A light beam (which will be hereinbelow simply denoted as a return light beam 103) is reflected from the optical disk 10 and is directed to the detected light receiving portion 47. The return beam is indicated by a dotted line. Moreover, that part (which will be simply denoted as “monitor light beam 102) of the out-going light beam which is in the zone where it is detected by the monitor beam receiving portion 44 is indicated by a two-dot chain line. It is noted that there are used two optical axes one of which is the optical axis T as the axis of the emitted light beam from the semiconductor laser 61, and the other one of which is an optical axis Z as the axis of the light beam extending between the objective lens 39 and the reflection mirror 65.

Estimation is now made such that an optical beam with linear polarization is emitted from the semiconductor laser 61. That is, the out-going light beam 101 is emitted. The light beam travels along the optical axis T while it is diffused. When it comes to the reflection mirror 65, it is reflected on the reflection surface 68, and then travels along the optical axis Z.

After the out-going light beam 101 is incident upon the polarizing plate 71, it transmits through the light guide member 72, and is then incident upon the hologram film 74. At this time, since the diffraction grating is formed in the hologram film 74 so that it does not act upon the polarizing direction of the out-going light beam 101, and accordingly, the out-going light beam 101 transmits through the hologram 74, and is then incident upon the next quarter wave plate 73.

On the way of transmission through the quarter wave plate 73, the out-going light beam 101 with linear polarization is turned into the one with circular polarization in which the phase thereof is turned by 90 deg. The out-going light beam 101 with circular polarization transmits through the guide member 72, and is converged by the objective lens 39 so as to be imaged onto a recording layer of the optical disc 10.

The optical beam reflected at the recording layer of the optical disk 10 is turned into the return light beam 103 which is returned along the optical path, reverse to the out-going light beam 101, having circular polarization in rotation reverse to that of the circular polarization of the out-going light beam 101, which has been changed thereinto upon reflection at the recording layer. Thus, after the return light beam is incident upon the polarizing plate 71, it transmits through the light guide member 72, and enters the quarter wave plate 73. During transmission through the quarter wave plate 73, the phase of the return light beam 103 with circular polarization is turned by 90 deg so as to be converted into the one with linear polarization. That is, the return light beam 103 with linear polarization has a phase difference of 180 deg. from the phase of the out-going light beam 101 with linear polarization. The polarizing direction of this return light beam 103 with linear polarization has an angle of 90 deg. with respect to that of the out-going light beam 101.

Then, it is incident upon the hologram film 74. At this time, the diffraction gratings of the hologram film 74 are formed so as to act upon the polarizing direction of the return light beam 103, and accordingly, the return light beam 103 is incident upon the reflection mirror 65 as a transmitted diffraction light beam under the action of the diffraction gratings 75 to 78. At this time, the transmitted diffraction light beam of the return light beam 103 is reflected at the reflecting surface 68 with a slight displacement with respect to the optical axis Z in strict meaning.

Thus, the return light beam 103 is separated away from the optical axis T, and is then incident upon the light receiving slope surface 56 of the submount 51. The return light beam 103 is again reflected at the light receiving slope surface 56, and is then incident upon the detected light receiving portion 47. In particular, the optical path of the out-going light beam 101 extending from the semiconductor laser 61 to the optical disk 10 and the optical path of the return light beam 103 extending from the optical disk 10 to the detected light receiving portion 47 are separated from each other by the hologram film 74 and the light receiving slope surface 56 of the submount 51, and accordingly, an extremely simple optical system can be configured.

For example, instead of the light receiving slope surface 56 of the submount 51, a polarization-separation type reflection mirror may be used. However, since the return light beam 103 has P-polarization, it is in general difficult to obtain a high reflectance ratio. Accordingly, with such a configuration that a half-wave plate is interposed between opposite surfaces of reflection films so that the out-going light beam incident upon the reflecting surface may have P-polarization while the return light beam may have S-polarization. However, its optical system would become complicated, and it would be possibly required to ensure the characteristics including a reflectance ratio.

It is noted that explanation has been made of the above-mentioned hologram film 74 shown in FIG. 6 which is a quadrant hologram. Further, the detected light receiving portion 47 is constituted by light receiving elements which are grouped into 8 zones as shown in FIG. 5. Accordingly, the focus control is carried out with the use of a spot size process while the tracking control is carried out with the use of a single beam P-P (push-pull) process. However, since the discussion as to the relationship among the hologram array, the light receiving array and the control process is not essential in the present invention, only general discussion have been made but its detail have been omitted.

That part of the out-going beam 101 which is in the zone where it is diffused travels along the optical axis T and is then incident upon the reflection mirror 65, having an incident angle which is greatly different from that in the center portion at the optical axis T since it is in the peripheral part of the diffused light. Accordingly, it travels to the optical axis Z after reflection upon the reflecting surface 68, but it further separates from the optical axis Z and is then incident upon the monitor beam receiving portion 44. That is, it is that part of an optical beam in the peripheral zone where the out-going light beam is diffused, which is in the zone detected by the monitor beam receiving portion 44 and which is turned into the monitor light beam 102. In particular, since a front monitor type in which a part of an emitted light beam from the semiconductor laser 51 is detected as a laser power control monitor beam, is used, it is precisely in proportion to a light power of the light beam which is main in the optical center part at the optical axis, and accordingly, the laser power control can be precisely made.

Conventionally, it has been, in general, required to locate the incident surface of the reflection mirror 61, being off from the monitor beam receiving portion 44 toward the light source in order to guide a part of the emitted light beam from the semiconductor laser 61 to the monitor beam receiving portion 44 on the OECI 41, and accordingly, there has been provided such an optical configuration that a special surface shape such as an elliptic surface shape or a hologram is formed on the reflecting surface 68 of the reflection mirror 65 in order to guide the light beam onto the monitor beam receiving portion 44. However, the peripheral part of the out-going light beam 101 which is a diffused light beam is used, as mentioned above, and according to the present invention, an optical system having a simple structure and low costs can be materialized.

Next, verification will be made of the external shape of the optical head 30 according to the present invention, an external shapes of an optical pickup using the optical head, and of an optical disk unit using the optical pickup.

The thickness of the optical disk unit is that of the unit which is sectioned in a plane perpendicular to the optical disc 10 loaded in the unit. The thickness of a conventional thin optical disc unit has been 12.7 mm, and the thickness of a base including an optical head and an arm (which are not shown) has been about 6 mm.

On the contrary, the thickness of each of the above-mentioned components will be listed up. That is, the lens holder 31 has a thickness of 2.2 mm, the polarizing plate 71 0.425 mm, the OEIC 41 0.25 mm, the submount 51 0.5 mm, the semiconductor laser 61 0.1 mm, the reflection mirror 65 1 mm, the HFM 63 0.25 mm and the FPC 27 0.07 mm.

When the above-mentioned components are assembled, the optical head 30 has a thickness of 2.95 mm which becomes about one-half of the thickness of the base including the optical head and the arm 21 in the conventional configuration. It is noted that the thickness of the optical head 30 corresponds to the distance from the upper surface of the objective lens 39 (which is on the surface side opposed to the optical disk) to the lower surface (rear surface) of the reflection mirror 65, as measured along the optical axis Z.

Further, the arm 21 may have a thickness of 1.6 mm, and the thickness between the upper surface of the objective lens 39 (which is the surface side opposed to the optical disk 10) and the lower surface of the arm 21 may be set to 3.05 mm. Thus, the optical head 30 and the arm 21 can be thinner, and accordingly, the optical pickup apparatus according to the present invention can have a thickness which is about one-half of that of the conventional one. Further, the optical disk unit using the optical pickup apparatus according to the present invention may have a thickness which is not greater than 11 mm. Thus, the optical head 30 according to the present invention can contribute to the miniaturization and thinning of the optical pickup apparatus and the optical disk unit.

As explained hereinabove, with the use of the optical pickup apparatus according to the present invention, there can be provided an optical pickup apparatus which is small-sized, lightweight and inexpensive and which can be used for recording and reproduction of a small-sized optical disk, and an optical disk unit using this optical pickup apparatus.

What is claimed is:

1. An optical pickup apparatus comprising a swing means arranged so as to be swingable over a recording surface of a recording medium, a swingable drive means for swingably driving the swing means, and a bringing means for briging the swing means to and from the recording medium, and an optical head provided at a swingable distal end part of the swing means, for recording and reproducing data to and from the recording medium, characterized in that:
the optical head comprises a holder member engaged and fixed to the swing means, an objective lens fixed to that surface of the holder member which is on a side opposed to the recording medium, a light source arranged on that surface side of the holder member which is in rear of the surface opposed to the recording medium, and a reflection mirror for guiding a light beam from the light source to the objective lens through the intermediary of a through-hole piercing through a front end part of the holder member, the light source is arranged on a light receiving means through the intermediary of a heat radiating member, and the light receiving means is arranged on that surface side of the holder member which is in rear of the surface opposed to the recording medium.

2. An optical pickup apparatus as set forth in claim 1, characterized in that the through-hole is provided therein with a polarizing plate formed in a parallel planar plate in which a quarter wave plate on the recording medium side, and a diffraction grating on the light source side are stacked.

3. An optical disc unit loaded therein with an optical recording medium and rotating the same, for recording and reproducing data to and from the optical recoding medium, characterized in that the optical pickup apparatus as set forth in claim 1 is used.

4. An optical pickup apparatus comprising a swing means arranged so as to be swingable over a recording surface of a recording medium, a swingable drive means for swingably driving the swing means, and a bringing means for briging the swing means to and from the recording medium, and an optical head provided at a swingable distal end part of the swing means, for recording and reproducing data to and from the recording medium, characterized in that:
the optical head comprises a holder member engaged and fixed to the swing means, an objective lens fixed to that surface of the holder member which is on a side opposed to the recording medium, a light source arranged on that surface side of the holder member which is in rear of the surface opposed to the recoding medium, and a reflection mirror for guiding a light beam from the light source to the objective lens through the intermediary of a through-hole piercing through a front end part of the holder member, the light source is provided to a light receiving means through the intermediary of a heat radiating member, the light receiving means is arranged on the rear surface side of the holder member which is on the side in rear of the surface opposed to the recording medium; and the through-hole is provided with a polarizing plate which is formed into a parallel planar plate in which a quarter wave plate on the recording medium side and a diffraction grating on the light source side are stacked is arranged, orthogonal to the through-hole.

5. An optical pickup apparatus as set forth in claim 4, characterized in that the heat radiating member is formed with a slope surface which serves as a reflecting surface for reflecting a light beam from the recording medium onto the light receiving means.

6. An optical pickup apparatus as set forth in claim 4, wherein the heat radiating member is mounted thereon with a high frequency modulation module together with the light source.

7. An optical pickup as set forth in claim 4, characterized in that said high frequency modulation module is mounted on the light receiving medium in the form of an integrated circuit.

8. An optical pickup apparatus as set forth in claim 4, characterized in that the light receiving means is formed with a reference maker for positioning the heat radiating member and the light source.

9. An optical pickup apparatus as set forth in claim 4, characterized in that the holder member is formed with a mounting surface for mounting thereon the heat radiating member.

10. An optical pickup apparatus as set forth in claim 4, characterized in that said polarizing plate is arranged so as to be finely adjustable with respect to the holder member in order to allow an light beam incident upon the light receiving means to be adjusted.

11. An optical disc unit loaded therein with an optical recording medium and rotating the same, for recording and reproducing data to and from the optical recording medium, characterized in that an optical pickup apparatus as set forth in claim 4 is used.

12. A method of assembling an optical pickup apparatus comprising a swing means arranged so as to be swingable over a recording surface of a recording medium, a swingable drive means for swingably driving the swing means, and a bringing means for briging the swing means to and from the recording medium, and an optical head provided at a swingable distal end part of the swing means, for recording and reproducing data to and from the recording medium, characterized by:
preparatory step of previously mounting a light source and a high frequency modulation module on a heat radiating member,
step of arranging a light receiving means on that surface side of the holder member which is in rear of a surface opposed to the recording medium,
step of arranging the heat radiating member on the light receiving means,
step of arranging a reflection mirror on that surface side of the holder member which is in rear of the surface opposed to the recording medium,
step of fixing an objective lens on that surface side of the holder member which is opposed to the recording medium,
step of arranging a polarizing plate formed into a parallel planar plate in which a quarter wave plate on the recording medium side and a diffraction grating on the light source side are stacked, on the holder member after it is positionally adjusted with respect to the holder member, and
step of fixing the holder member to the swing means so as to fix the optical head.

13. An optical pickup apparatus comprising a swing means arranged so as to be swingable over a recording surface of a recording medium, a swingable drive means for swingably driving the swing means, and a bringing means for briging the swing means to and from the recording medium, and an optical head provided at a swingable distal end part of the swing means, for recording and reproducing data to and from the recording medium, characterized in that:
the optical head comprises a holder member engaged and fixed to the swing means, an objective lens fixed to that surface of the holder member which is on a side opposed to the recording medium, a light receiving means arranged on that surface side of the holder member which is in rear of the surface opposed to the recording medium, a light source provided to the light receiving means through the intermediary of a heat radiating member, a reflection mirror for guiding a light beam from the light source to the objective lens through the intermediary of a through-hole piercing through a front end part of the holder member, and a polarizing plate arranged so as to extend orthogonal to the through-hole, characterized in that the polarizing plate is formed into a parallel planar plate in which a quarter wave plate on the recording medium side and the diffraction grating on the light source side are stacked, and is inserted in the through-hole, and the heat radiating member is formed therein with a slope surface which serves as a reflecting surface for guiding a light beam reflected from the recording medium onto the light receiving means.

14. An optical pickup apparatus as set forth in claim 13, characterized in that the heat radiating member is mounted thereon with a high frequency modulation module together with the light source.

15. An optical pickup apparatus as set forth in claim 13, characterized in that the light receiving means is mounted thereon with a high frequency modulation module together with the heat radiating member.

16. An optical pickup apparatus as set forth in claim 13, characterized in that the light receiving means is formed therein with a reference marker for positioning the heat radiating member and the optical source.

17. An optical pickup apparatus as set forth in claim 13, characterized in that the holder member is formed therein with a mounting surface for mounting thereon the heat radiating member.

18. An optical pickup apparatus as set forth in claim 13, characterized in that the polarizing plate is arranged so as to be positionally adjustable finely with respect to the holder member in order to allow a light beam incident upon the light receiving means to be adjustable.

19. An optical disk unit loaded thereon with an optical recording medium and rotating the same, for recording and reproducing data to and from the optical recording medium, characterized in that an optical pickup apparatus as set forth in claim 13 is used.
